(19) United States
(12) Patent Application Publication
(10) Pub. No.: US 2017/0006861 A1
(43) Pub. Date: Jan. 12, 2017

(54) ANIMAL ATTRACTANT AND REPELLANT AND METHOD OF MAKING THE SAME

(71) Applicant: Great Lakes Cordage Company, Grand Haven, MI (US)

(72) Inventors: Jeffery Bovid, Nunica, MI (US); Kelle Bovid, Nunica, MI (US)

(73) Assignee: Great Lakes Cordage Company, Grand Haven, MI (US)

(21) Appl. No.: 15/202,086

(22) Filed: Jul. 5, 2016

Related U.S. Application Data
(60) Provisional application No. 62/188,770, filed on Jul. 6, 2015.

(51) Int. Cl. A01N 25/34; B31D 5/00; A01N 25/10; B31C 99/00; A01K 29/00; A01K 15/02

(52) U.S. Cl. CPC A01N 25/34; A01K 29/00; A01K 15/025; A01K 15/024; A01N 25/10; B31C 13/00; B31D 5/0091

(57) ABSTRACT

A paper product that includes an article of paper, a binding agent disposed on a surface of the article of paper, and an animal-affecting substance. The animal-affecting substance is bound to the strip of paper via the binding agent and the paper is in a twisted cord configuration such that the animal-affecting substance is disposed within an interior defined by the article of paper.

### CROSS-REFERENCE TO RELATED APPLICATIONS

This application claims the benefit of and priority to U.S. Provisional Patent Application No. 62/188,770, filed on Jul. 6, 2015, entitled “ANIMAL ATTRACTANT AND REPELLANT AND METHOD OF MAKE THE SAME,” the entire disclosure of which is hereby incorporated herein by reference.

### TECHNICAL FIELD

The present disclosure generally relates to animal attractant products, animal repellant products, and methods of making these products. Embodiments described herein relate to paper twisted articles including animal attractants and repellants.

### BACKGROUND

Conventional pet toys having an applied attractant may suffer from a fading of the efficacy of the attractant over the lifecycle of the toy. While the physical hardware of the toy is still usable, the animal has lost interest in it due to the lack of noticeable attractant. Additionally, conventional pet toys incorporating attractants and repellants are not compostable, biodegradable, or recyclable, leading to the eventual discarding of the toy into a landfill at the end of its life cycle.

### SUMMARY

According to one aspect of this disclosure, a paper product for animals contains an article of paper, a binding agent disposed on an interior surface of the article of paper and an animal-affecting substance. The animal-affecting substance is bound to the interior surface of the article of paper via the binding agent and the paper is in a twisted cord configuration such that the animal-affecting substance is disposed within an interior defined by the article of paper.

According to another aspect of this disclosure, a method of forming a paper product for animals comprising the steps of moistening an article of paper, applying a binding agent to a surface of the paper and applying an animal-affecting substance to the binding agent, twisting the paper into a twisted cord such that the binding agent and the animal-affecting substance is disposed within an interior defined by the cord.

Additional features and advantages will be set forth in the detailed description which follows, and, in part, will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

FIG. 1A is a top perspective view of an unraveled paper product according to one embodiment;

FIG. 1B is a top perspective view of the paper product depicted in FIG. 1A in a partially twisted configuration;

FIG. 2A is a perspective view of a paper product for an animal in use according to one embodiment;

FIG. 2B is a perspective view of a paper product for an animal in use according to another embodiment; and

FIG. 3 is a perspective view of a paper product for an animal in use according to a further embodiment.

### DETAILED DESCRIPTION

Additional features and advantages of the invention will be set forth in the detailed description which follows and will be apparent to those skilled in the art from the description or recognized by practicing the invention as described in the following description together with the claims and appended drawings.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

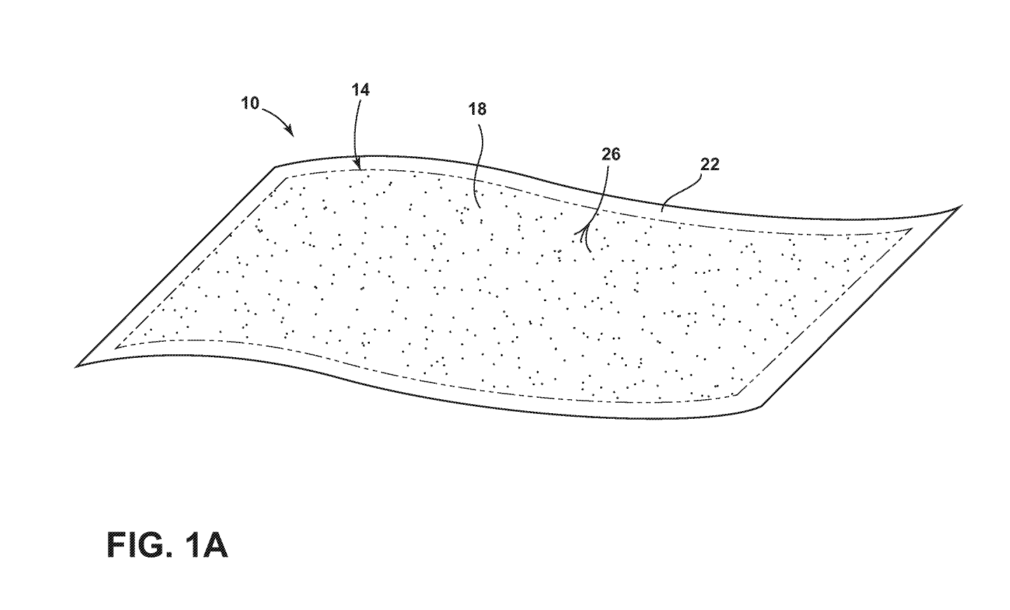

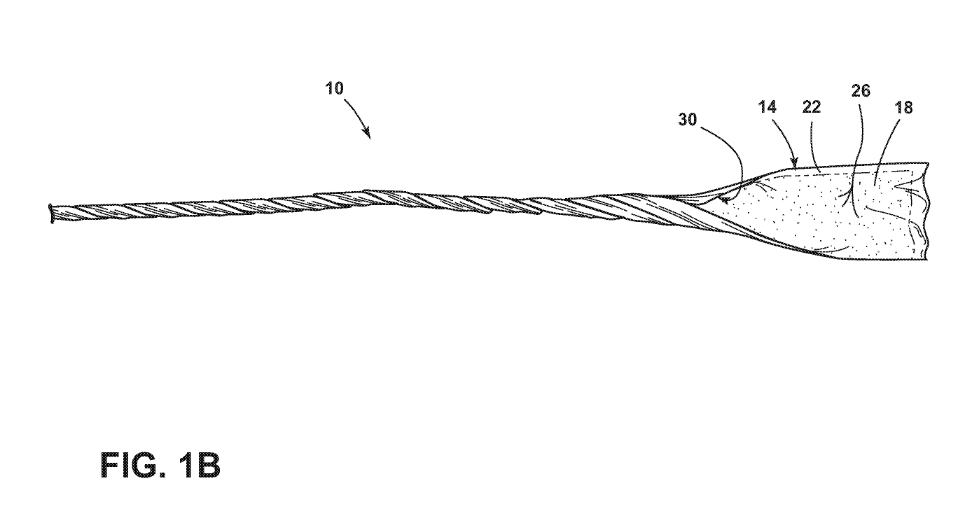

With reference to FIGS. 1A-3, reference numeral 10 generally designates a paper product. The paper product 10 includes a paper article 14 having a binding agent 18 disposed on a surface 22 of the paper article 14. An animal-affecting substance 26 may be disposed on or in the binding agent 18, thereby binding the animal-affecting substance to the paper article 14. The paper article 14 is in a twisted configuration such that the animal-affecting substance is disposed within an interior 30 of the paper product 10. Optionally, the paper product 10 may be coupled to a charm 38.

Referring now to the depicted embodiment of FIG. 1A, the paper article 14 has a rectangular strip configuration, but may also be square, oval, or circular in shape. The paper article 14 may be formed from a variety of paper stocks including recycled or virgin stock. In recycled embodiments, the paper article 14 may include towel tissue, kraft paper, recycled corrugated containers, mixed paper, recycled newspaper, high grade deinked paper, pulp substitutes, and combinations of these materials. The basis weight of the paper article 14 may be low weight, medium weight, or medium high weight. A finish of the paper article 14 may be coarse, fine, calendered, super calendered, machine finished, machine glazed, or glossed. The paper article 14 may be bleached or unbleached.

The binding agent 18 may include wheat flour, rice starch, potato starch, maize starch, corn starch, tapioca starch, ferula gummosa boiss, gum olibanum, beilschmiedia seed gum, okro gum, aegle marmelod gum, gum cordial, okra gum and cassia roxburghii seed gum, pectin, food grade binding agents, or combinations thereof. In some embodiments, the binding agent 18 may be sprayed onto the surface 22 of the paper article 14, while in other embodiments the binding agent 18 may be rolled or painted onto the paper article 14. In some embodiments, the binding agent 18 may be mixed with the animal-affecting substance 26 to form a pre-mix such that a single step deposits both the animal-affecting substance and the binding agent 18. In other embodiments, the binding agent 18 and the animal-affecting substance 26 may be applied to the surface 22 of the paper article 14 in separate steps. In various embodiments, the binding agent 18 and/or the animal-affecting substance 26 may be applied to both sides of the paper article 14. In some embodiments, the binding agent 18 and/or animal-affecting substance 26 may be applied in a pattern.

Dispersed on and/or within the binding agent 18 may be the animal-affecting substance 26. The animal-affecting substance 26 may be an attractant, a repellant, or a substance designed to have another effect on an animal or particular animal species (e.g., kill, disorient, irritate). The animal-affecting substance 26 may have an average particle diameter of between about 0.010 inches to about 0.20 inches, and more preferably between about 0.050 to about 0.150 inches. In a specific embodiment, the average particle diameter is about 0.090 inches. In attractant embodiments, the animal-affecting substance 26 may include a substance comprising actinidine, actinidiolide, boschnialactone, boschniakine, dihydroactinidiolide, dihydronepetalactone, epinepetalactone, iridomyrmecin, isodihydronepetalactone, mitsugashiwalactone, nepetalactone, neonepetalactone, onikulactone, feline pheromones (e.g., from urine, glandular secretions, feces), food odors (e.g, meat, vegetables, animals), and combinations thereof. Specific examples of natural materials that may include one or more of these compounds include nepeta cataria, valerian, nepeta nepetell, nepeta, nepeta discolor, nepeta racemosa. Further, a blend of these materials may be used in conjunction with artificially produced animal-affecting substance 26 employed as an attractant. In some embodiments, when a plant material is used as the animal-affecting substance 26, the plant material may be organic.

In various other embodiments, the animal-affecting substance 26 may be a repellant. Examples of repellant forms of the animal-affecting substance 26 include coleus canina, citrus, citronella oil, castor oil, castor beans, pheromones or scents (e.g., glandular secretions, urine, feces, etc.) of a predator (e.g., a predator to the animal being repelled), pepper, methyl nonyl ketone, and combinations thereof. For example, in predator pheromone embodiments of the animal-affecting substance 26, if the animal intended to be repelled is a rabbit, the pheromones of predators of the rabbit (e.g., coyote, felines, dogs, etc.) may be used. Similar to the embodiments of the animal-affecting substance 26 comprising a repellant, the animal-affecting substance 26 may be a substance designed to irritate the animal, thereby deterring future interaction with the paper product 10. In such embodiments, the animal-affecting substance 26 can include spicy peppers containing capsaicin, black pepper, or other materials tailored to irritate a particular species of animal or pest.

Referring now to FIG. 1B, once the binding agent 18 and the animal-affecting substance 26 have been applied to the surface 22 of the paper article 14, the paper article 14 is twisted such that the binding agent 18 and the animal-affecting substance 26 are disposed within the interior 30 of the paper product 10. By placing the animal-affecting substance 26 within the interior 30 of the paper product 10, the longevity of the animal-affecting substance 26 may be increased. In various other embodiments, the paper article 14 may be rolled or folded to produce a structure similar to the paper product 10 without departing from the spirit of this disclosure. In one implementation, the paper article 14 may be twisted in a helical configuration such that the paper article 14 has a twist of between about 1 turn per linear foot and about 20 turns per linear foot, and, more specifically, between about 5 turns to about 15 turns per linear foot. In a specific embodiment, the paper article 14 has about 13 turns per linear foot.

In an exemplary manufacturing process, the paper article 14 may start on a large roll from which the width of the paper article 14 is cut into a continuous strip. From there, the paper article 14 engages a rotatable roller which extends in part into a pan or tray containing a wetting or sizing agent. To insure against an excessive application of the wetting or sizing agent to the paper article 14, a scraper may be provided to remove excessive quantities of the wetting agent. The binding agent 18 is then applied to the surface 22 of the paper article 14 followed by the animal-affecting substance 26. Next, the paper article 14 is passed through a forming die which causes the paper article 14 to twist, roll, or fold based on the desired final configuration of the paper product 10. The paper article 14 is then rolled onto a spool and later cut to length for sale or for use in another end product. The final diameter of the paper product 10 may be between about 0.1 inches and about 0.2 inches. In a specific embodiment, the final diameter is about 0.16 inches.

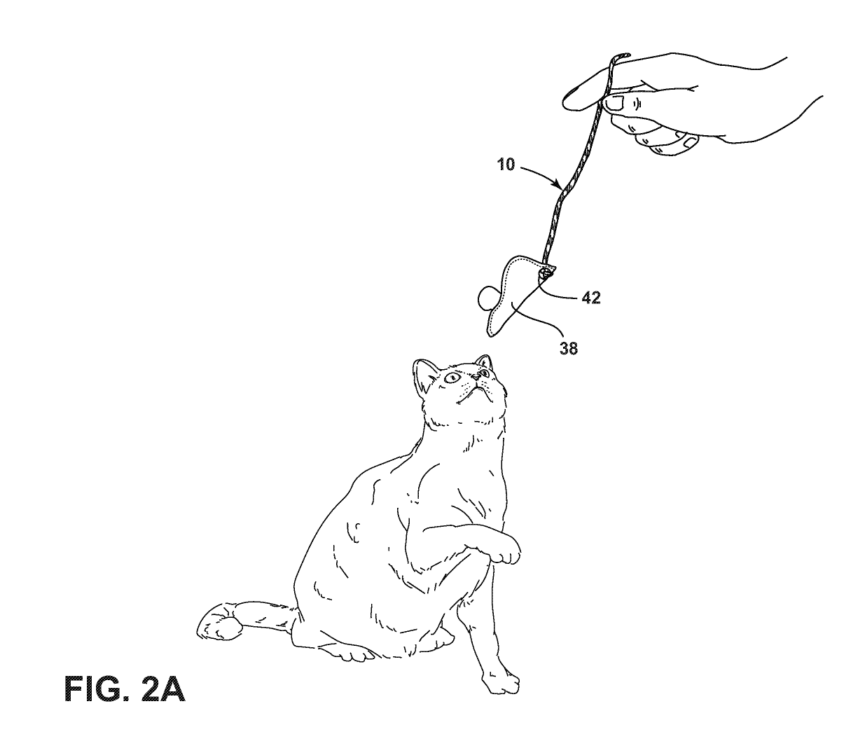

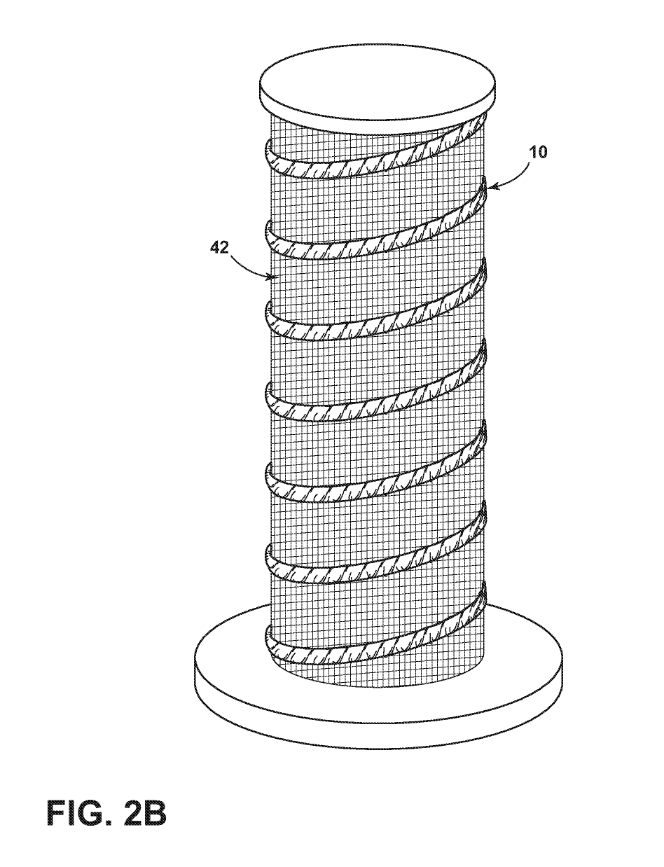

Referring now to FIG. 2A-2B, in embodiments where the paper product 10 is configured to attract animals, the paper product 10 may be configured as an attractant toy and toy accessory for cats.

Referring now to FIG. 2A, the paper product 10 may contain cat nip (e.g., nepeta cataria) as the animal-affecting substance 26. In such an embodiment, the paper product 10 may be cut to length and dangled in front of a cat in order to induce playing and jovial spirits within the cat. In embodiments where the animal-affecting substance 26 is configured to attract an animal, a charm 38 may be attached to the paper product 10 and shaped or otherwise configured to attract the animal. In the embodiment depicted in FIG. 2A, the charm 38 is shaped like a mouse, but may alternatively be a geometric shape (e.g., ball, cube, pyramid, pillow), a fish, an insect or include feathers. The paper product 10 may be threaded through a hole 42 defined by the charm 38 and secured thereto (e.g., by tying a knot in the paper product 10 to resist decoupling of the charm 38 and the paper product 10). In various embodiments, the charm 38 may be filled or otherwise scented with any of the animal attractants described earlier.

Referring now to FIG. 2B, the paper product 10 may be wrapped around objects which a user desires to be a source of attraction for the cat. In the depicted embodiment, the paper product 10 may be wrapped around a scratching post 42 to induce the cat to get near the scratching post 42 such that the cat is induced to scratch it. Should the cat harm the paper product 10 during scratching, the paper product 10 may simply be removed from the scratching post 42 and replaced with a fresh piece of paper product 10. As the paper product 10 is flexible and may be cut to any length the user desires, the paper product 10 may advantageously take a variety of shapes and sizes of objects the user wants to be a source of attraction for the cat. Additionally, in embodiments where the paper product 10 is biodegradable, the user may compost or otherwise dispose of the paper product 10 in an environmentally friendly manner.

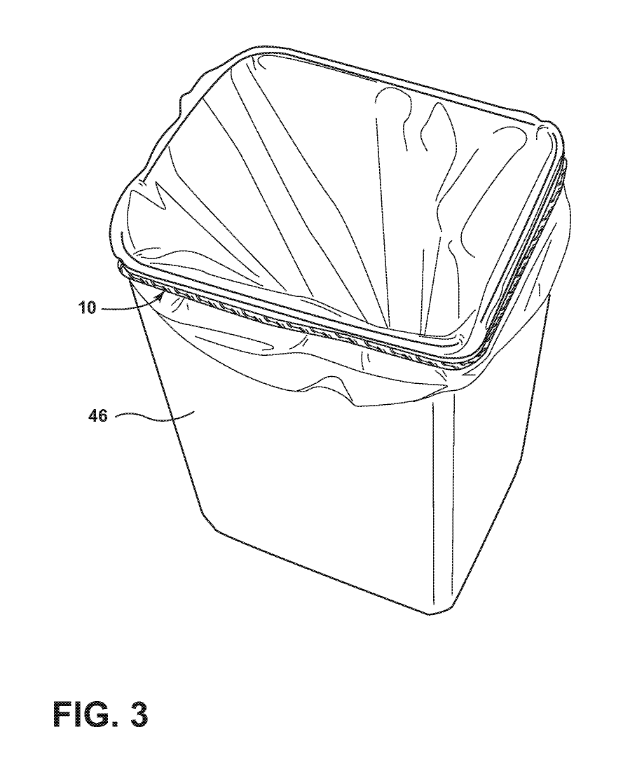

Referring now to FIG. 3, depicted is an embodiment of the paper product 10 incorporating a repellant embodiment of the animal-affecting substance (e.g., substance 26). In such an embodiment, the paper product 10 may be placed on or around an item or space designated by the user as needing protection from animal interference (e.g., trash can, garden, under deck area, food). In the depicted embodiment, the paper product 10 is wrapped around a trash can 46. Utilization of the paper product 10 may allow for the quick and easy replacement of a repellant material, as well as a long lasting repellant effect. Additionally, use of the paper product 10 allows for the easy application of repellant to objects without having to directly apply a repellant to the object (e.g., a liquid spray to the trash can 46) which may damage or otherwise harm the object.

While the embodiments disclosed herein have been set forth for the purpose of illustration, the foregoing description should not be deemed to be a limitation on the scope of the disclosure or the appended claims. For example, the animal-affecting substance 26, a biodegradable embodiment of the paper product 10, may be replaced with a fertilizer, such that precise applications of fertilizer can be applied to a garden or flower bed. Accordingly, various modifications, adaptations, and alternatives may occur to one skilled in the art without departing from the spirit and scope of the present disclosure or the appended claims.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims as interpreted according to the principles of patent law, including the doctrine of equivalents.

It will be understood by one having ordinary skill in the art that construction of the described disclosure, and other components, is not limited to any specific material. Other exemplary embodiments of the disclosure disclosed herein may be formed from a wide variety of materials, unless described otherwise herein.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature, or may be removable or releasable in nature, unless otherwise stated.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the system may be varied, and the nature or numeral of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes, or steps within described processes, may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and, further, it is to be understood that such concepts are intended to be covered by the following claims, unless these claims, by their language, expressly state otherwise. Further, the claims as set forth below, are incorporated into and constitute part of this Detailed Description.

What is claimed is:

1. A paper product for animals, comprising:
an article of paper;
a binding agent disposed on an interior surface of the article of paper; and
an animal-affecting substance,
wherein the animal-affecting substance is bound to the interior surface of the article of paper with the binding agent and the article of paper in a twisted cord configuration such that the animal-affecting substance is disposed within an interior defined by the article of paper.

2. The paper product of claim 1, wherein the animal-affecting substance is an attractant.

3. The paper product of claim 2, wherein the attractant comprises at least one feline attractant selected from the group consisting of actinidine, actinidiolide, boschnialactone, boschniakine, dihydroactinidiolide, dihydronepetalactone, epinepetalactone, iridomyrmecin, isodihydronepetalactone, mitsugashiwalactone, nepetalactone, neonepetalactone, onikulactone, feline pheromones, and food odors.

4. The paper product of claim 1, wherein the binding agent comprises at least one substance selected from the group consisting of wheat flour, rice starch, potato starch, maize starch, corn starch, tapioca starch, ferula gummosa boiss, gum olibanum, beilschmiedia seed gum, okro gum, aegle marmelod gum, gum cordial, okra gum and cassia roxburghii seeds gum, and pectin.

5. The paper product of claim 1, wherein the animal-affecting substance is a repellant.

6. The paper product of claim 5, wherein the repellant comprises at least one substance selected from the group consisting of citrus, castor oil, castor beans, coleus caning, citrus, citronella oil, castor oil, castor beans, predator pheromones, pepper, methyl nonyl ketone, and combinations thereof.

7. The paper product of claim 1, wherein the article of paper comprises recycled paper.

8. The paper product of claim 7, wherein the twisted cord configuration has between five and fifteen turns per linear foot.

9. The paper product of claim 8, wherein the animal-affecting substance is configured as a plurality of particles.

10. The paper product of claim 9, wherein the particles of the animal-affecting substance have an average particle diameter of between about 0.010 inches to about 0.20 inches.

11. A method of forming a paper product for animals comprising the steps of:
moistening an article of paper;
applying a binding agent to a surface of the paper;
applying an animal-affecting substance to the binding agent;
twisting the paper into a twisted cord such that the binding agent and the animal-affecting substance are disposed within an interior defined by the cord.

12. The method of forming a paper product of claim 11, wherein the animal-affecting substance is an attractant.

13. The method of forming a paper product of claim 12, wherein the attractant comprises at least one feline attractant selected from the group consisting of actinidine, actinidiolide, boschnialactone, boschniakine, dihydroactinidiolide, dihydronepetalactone, epinepetalactone, iridomyrmecin, isodihydronepetalactone, mitsugashiwalactone, nepetalactone, neonepetalactone, onikulactone, feline pheromones, and food odors.

14. The method of forming a paper product of claim 11, wherein the binding agent comprises at least one substance selected from the group consisting of wheat flour, rice starch, potato starch, maize starch, corn starch, tapioca starch, ferula gummosa boiss, gum olibanum, beilschmiedia seed gum, okro gum, aegle marmelod gum, gum cordial, okra gum and cassia roxburghii seeds gum, pectin and combinations thereof.

15. The method of forming a paper product of claim 11, wherein the animal-affecting substance is a repellant.

16. The method of forming a paper product of claim 15, wherein the repellant comprises at least one substance selected from the group of citrus, castor oil, castor beans, coleus canina, citrus, citronella oil, castor oil, castor beans, predator pheromones, pepper, methyl nonyl ketone, and combinations thereof.

17. The method of forming a paper product of claim 11, wherein the article of paper comprises recycled paper.

18. The method of forming a paper product of claim 17, wherein the twisted cord has between five and fifteen turns per linear foot.

19. The method of forming a paper product of claim 18, wherein the animal-affecting substance is configured as a plurality of particles.

20. The method of forming a paper product of claim 19, wherein the particles of the animal-affecting substance have an average particle diameter of between about 0.010 inches and about 0.20 inches.
